(19) United States
(12) Patent Application Publication
(10) Pub. No.: US 2011/0076462 A1
(43) Pub. Date: Mar. 31, 2011

(54) EDGE REINFORCED ELASTOMERIC MEMBRANES

(76) Inventors: Steven R. Jette, Auburn, MA (US); James Holtzinger, Clifton Park, NY (US); Senthil K. Jayaseelan, Troy, NY (US)

(21) Appl. No.: 12/849,121

(22) Filed: Aug. 3, 2010

Related U.S. Application Data
(60) Provisional application No. 61/231,190, filed on Aug. 4, 2009.

(51) Int. Cl. B32B 3/02; C09J 5/02; B32B 25/20; B32B 25/18; B32B 25/10; B32B 25/16

(52) U.S. Cl. 428/193; 156/307.3; 428/192

(57) ABSTRACT

The invention describes a pliable elastomeric membrane that is seamless and is prepared by mold processing. By utilizing mold processing, the ultimate membrane or sheet is several times larger in length and/or with than those elastomeric membranes or sheets as dictated by current calendaring processes. The present process provides the ability to form elastomeric sheets that can be reinforced about the perimeter, thus preventing tearing of the sheet while in use in, for example, vacuum laminators.

### CROSS REFERENCE TO RELATED APPLICATIONS

This application claims benefit under 35 U.S.C. §119(e) to U.S. Ser. No. 61/231,190, entitled “EDGE REINFORCED ELASTOMERIC MEMBRANES”, filed Aug. 4, 2009 (attorney docket number SGPP-034/PROV 0-6011) the contents of which are incorporated herein by reference in their entirety.

### FIELD OF THE INVENTION

The invention relates generally unique seamless elastomeric membranes with reinforced edges, suitable for use in laminators. The edge of the laminate is reinforced to provide a robust surface for clamping, bolting, screwing and the like about the circumference of a laminator while providing a pliable interior that can conform to an article, such as a photovoltaic device, while vacuum or pressure is applied.

### BACKGROUND OF THE INVENTION

Vacuum lamination is a commonly used method to form and combine multiple layered structures. One particular use is in the formation of electronic or optoelectronic devices including photovoltaic modules. The laminator applies pressure and heat while extracting air from the stacked components to be adhered. It is particularly effective for photovoltaic modules that use a sealing or encapsulant layer of ethylene vinyl acetate (EVA), as these formulations commonly do not cure in the presence of oxygen. Vacuum lamination is also quite effective in applying steady, gentle pressure to the delicate components and connections that may be present within photovoltaic modules. U.S. Pat. No. 4,450,034 provides a description of one type of vacuum laminator, although a variety of configurations may be employed and this is not meant to be a limiting example.

In many vacuum laminators an elastomeric diaphragm is used to transmit pressure. In a common configuration, a diaphragm is clamped beneath an upper chamber and held in place by suction, the apparatus is closed, a lower chamber is evacuated, and the upper chamber is allowed to fill with air. The net effect is to push the membrane against the stack to be laminated with gentle pressure. The diaphragm used is a flexible elastomeric sheet that can readily deform and conform to any irregularities across the module surface so as to even the application of pressure. Most often, these sheets are cured rubber sheets without reinforcement. However, the diaphragm must be held within the laminator for correct placement, and formation of an air tight seal. This may be accomplished by a variety of mechanical means such as clamps, screws or bolts. All of these mechanical means necessarily grip and/or puncture the sheet providing sources of stress concentration or potential points of wear. It is also possible to attach the diaphragm within the laminator by adhesive means. For both mechanical and adhesive means, in addition to stresses in the actual attachment area, there may stresses at the edge of the chamber near the attachment means where the membrane may flex or curve repeatedly, or contact and rub upon the chamber edge each time it is raised or lowered. As such, the area of attachment and the nearby chamber edge can be sources of wear resulting in poor durability of the diaphragm, and necessitating more frequent diaphragm replacement.

Therefore, a need exists for a flexible elastomeric sheet that addresses one or more of the current disadvantages of existing lamination technology.

### BRIEF SUMMARY OF THE INVENTION

The present invention provides a perimeter reinforced pliable membrane, e.g., a molded membrane, that includes a pliable membrane with a perimeter portion and an interior portion. The perimeter of the pliable membrane is reinforced with a supporting substrate and the interior portion does not comprise the supporting substrate. In one aspect, the pliable membrane is seamless. Primarily based on the process of preparation, the seamless pliable membrane can be prepared in various sizes, including 3 meters by 5 meters. Use of uncured sheet material to prepare the pliable membrane provides the unexpected advantage of forming sheet sizes not readily available.

Generally, the pliable membrane comprises an elastomer which can be an ethylene propylene diene M-class rubber, a silicone elastomer, a fluorosilicone, an FKM, EPDM, IIR, or butyl rubber. The supporting substrate can be a fabric, chopped fibers, or nonwoven. Suitable fabric or nonwoven materials can be glass fibers, nylons, polyesters, aramids, steel meshes, polyimides, carbon fiber or mixtures thereof.

In another aspect, the pliable membrane does not include the reinforcement material (supporting substrate). The pliable membrane is unique due to the dimensions achieved by the mold process utilized to adhere uncured sheet material to each other.

The present invention also provides processes to provide perimeter reinforced pliable membranes. The steps include
a) processing an elastomer, optionally with an additive to form a first mixture;
b) contacting the first mixture with a fiber supporting substrate to form a supported sheet wherein a portion of the mixture is integrally enjoined within or about individual fibers of the supporting substrate to provide a reinforced material;
c) sizing the reinforced material to a dimension suitable to cover an edge zone of a laminator or other pressure membrane device;
d) processing an elastomer, optionally with an additive to form a second mixture;
e) processing the second mixture into a sheet;
f) layering of the reinforced material about the perimeter of the sheet to provide an uncured perimeter reinforced pliable membrane; and
g) mold processing the uncured perimeter reinforced pliable membrane to form a perimeter reinforced pliable membrane.

The present invention also provides processes to provide a seamless pliable membrane. The method includes the steps:
a) processing an elastomer, optionally with an additive to form a first mixture;
b) processing the first mixture into an uncured sheet;
c) processing an elastomer, optionally with an additive to form a second mixture;
e) processing the second mixture into an uncured sheet; and
f) mold processing and curing the first and second uncured sheets to each other to form a seamless pliable membrane.

While multiple embodiments are disclosed, still other embodiments of the present invention will become apparent to those skilled in the art from the following detailed description. As will be apparent, the invention is capable of modifications in various obvious aspects, all without departing from the spirit and scope of the present invention. Accordingly, the detailed descriptions are to be regarded as illustrative in nature and not restrictive.

### BRIEF DESCRIPTION OF THE DRAWINGS

FIG. 1 depicts one embodiment of the invention.

### DETAILED DESCRIPTION

In the specification and in the claims, the terms “including” and “comprising” are open-ended terms and should be interpreted to mean “including, but not limited to . . . ” These terms encompass the more restrictive terms “consisting essentially of” and “consisting of.”

It must be noted that as used herein and in the appended claims, the singular forms “a”, “an”, and “the” include plural reference unless the context clearly dictates otherwise. As well, the terms “a” (or “an”), “one or more” and “at least one” can be used interchangeably herein. It is also to be noted that the terms “comprising”, “including”, “characterized by” and “having” can be used interchangeably.

Unless defined otherwise, all technical and scientific terms used herein have the same meanings as commonly understood by one of ordinary skill in the art to which this invention belongs. All publications and patents specifically mentioned herein are incorporated by reference in their entirety for all purposes including describing and disclosing the chemicals, instruments, statistical analyses and methodologies which are reported in the publications which might be used in connection with the invention. All references cited in this specification are to be taken as indicative of the level of skill in the art. Nothing herein is to be construed as an admission that the invention is not entitled to antedate such disclosure by virtue of prior invention.

Vacuum lamination is a commonly used method to form photovoltaic modules. The laminator applies pressure and heat while extracting air from the stacked components to be adhered. It is particularly effective for photovoltaic modules that use a sealing or encapsulant layer of ethylene vinyl acetate (EVA), as these formulations commonly do not cure in the presence of oxygen. Vacuum lamination is also quite effective in applying steady, gentle pressure to the delicate components and connections that may be present within photovoltaic modules. U.S. Pat. No. 4,450,034 provides a description of one type of vacuum laminator, although a variety of configurations may be employed and this is not meant to be a limiting example.

In vacuum laminators used for photovoltaic modules an elastomeric diaphragm is used to transmit pressure. In a common configuration, a diaphragm is clamped beneath an upper chamber and held in place by suction, the apparatus is closed, a lower chamber is evacuated, and the upper chamber is allowed to fill with air. The net effect is to push the membrane against the stack to be laminated with gentle pressure. The diaphragm used is a flexible elastomeric sheet that can readily deform and conform to any irregularities across the module surface so as to even the application of pressure. Most often, these sheets are cured rubber sheets without reinforcement.

The presence of reinforcement, while improving strength and durability, makes the sheet stiffer and less able to deform. However, the diaphragm must be held within the laminator for correct placement, and formation of an air tight seal. This may be accomplished by a variety of mechanical means such as clamps, screws or bolts. All of these mechanical means necessarily grip and/or puncture the sheet providing sources of stress concentration or potential points of wear. It is also possible to attach the diaphragm within the laminator by adhesive means.

For both mechanical and adhesive means, in addition to stresses in the actual attachment area, there may stresses at the edge of the chamber near the attachment means where the membrane may flex or curve repeatedly, or contact and rub upon the chamber edge each time it is raised or lowered. As such, the area of attachment and the nearby chamber edge can be sources of wear resulting in poor durability of the diaphragm, and necessitating more frequent diaphragm replacement.

It is possible to improve durability by including a reinforced membrane, as for example in Japanese patent publication JP2004-2818, however this published application discloses a reinforced sheet throughout the entire membrane area. Such a construction provides durability at the attachment and flex zones, but does not conform like that of a non-reinforced elastomer membrane.

By way of comparison, a fabric reinforced membrane might have a tensile strength of about 3,200 to 4,500 psi while a similar non-reinforced membrane might have a tensile strength of about 900 to 1,200 psi, indicating greater strength within the reinforced construction. Conversely, a fabric reinforced membrane might have an ultimate elongation of about 400 to 500% while a similar non-reinforced membrane might have an ultimate elongation of about 600 to 800%, indicating greater deformability within the un-reinforced construction.

There is a need for a flexible elastomeric sheet in the central portion of the laminator diaphragm to provide conformability while at the same time there is a need for a reinforced sheet around the edge of the laminator diaphragm to provide mechanical durability and improved wear resistance. The present invention describes a single structure that provides both of these characteristics.

In certain diaphragm applications it is possible to reinforce edges by gluing or bonding additional thickness of material or reinforcing fabric at the edges. However such designs suffer from potential failure of the glued piece and provide less durability than an elastomeric membrane with an integral reinforcement. Additionally, the presence of a glued layer provides a thickness discontinuity which can cause a variety of problems such as nonuniform distribution of stress during sealing of the laminator. The present invention overcomes this deficiency by providing a method to produce a molded diaphragm of essentially uniform thickness with integrally reinforced edges.

As photovoltaic module technology develops, modules of increasing greater size can be produced, and may provide desirable economics. Such modules require larger laminators and consequently larger membranes, and so there is also a need for laminator membranes of a finished size that is larger than the size produced by currently available calendaring technology. The present invention also provides molded/seamless membranes that can be prepared in sizes much larger than typical sheet material. Current calendaring technology limits the size of the sheet. Since the process utilized herein provides “uncured” sheets, the uncured sheets can be placed in contact with each other and then cured, thus providing seamless membranes or sheet. This aspect provides a distinct advantage over current sheet material that is limited in size. Currently, sheets that could be constructed together are done so by mechanical fasteners, such as stitching or with adhesives. The present invention avoids the necessity of mechanical methods to attach two or more sheets (which could cause tears, weak points between sheets, gaps, etc.) or the use of adhesives that may not uniformly adhere to the separate sheets.

The terms “elastic” and “elastomeric” are used interchangeably to mean a material that is generally capable of recovering its shape after deformation when the deforming force is removed. Specifically, as used herein, elastic or elastomeric is meant to be that property of any material which upon application of a biasing force, permits the material to be stretchable to a stretched biased length which is at least about 50 percent greater than its relaxed unbiased length, and that will cause the material to recover at least 40 percent of its elongation upon release of the stretching elongating force after the first stretching cycle. A hypothetical example which would satisfy this definition of an elastomeric material would be a one (1) inch sample of a material which is elongatable to at least 1.50 inches and which, upon being elongated to 1.50 inches and released, will recover to a length of at least 1.30 inches after the first stretching cycle. Many elastic materials may be stretched by much more than 50 percent of their relaxed length, and many will recover to substantially their original relaxed length upon release of the stretching, elongating force. Addition of reinforcement to an elastomer will generally reduce the amount of stretch below that of the non-reinforced elastomer.

The term “recover” refers to a contraction of a stretched material upon termination of a biasing force following stretching of the material by application of the biasing force.

One class of elastomeric materials comprises thermoset elastomers which are long chain amorphous polymers that are crosslinked during a curing step. Another class of elastomeric materials comprise thermoplastic elastomers which are copolymers or physical mixtures of polymers which achieve their elastomeric properties by interaction within phases of the polymer or mix. Thermoplastic elastomers may be formed by heat and pressure, but do not generally require curing to achieve elastomeric properties.

Among the useful elastomers are elastomeric block copolymers are those having structure A-B, A-B-A, A-(B-A)ₙ-B, or (A-B)ₙ—Y. Examples of these block copolymers include styrene-butadiene (SB), styrene-butadiene-styrene (SBS), styrene-isoprene-styrene (SIS), styrene-isoprene (SI), styrene-ethylene-butylene-styrene (SEBS), styrene-ethylene-butylene (SEB) styrene-ethylene propylene-styrene (SEPS), isoprene-isobutylene rubbers (IIR) and styrene-ethylene propylene (SEP).

Such block copolymers are available from Kraton Polymers, Enichem, Atofina Elastomers and Dexco. Multiblock or tapered block copolymers (the A-(B-A)ₙ-B type) are available from Firestone.

The block copolymer is SEBS available from Kraton Polymers under the trade designation Kraton G.

Among the useful elastomers are EPR rubber, EPDM rubber and/or blends of EPR and EPDM. The term EPR, as used herein, refers to elastomeric copolymers of ethylene and propylene, or such copolymers modified with functional monomers. The functional monomers include a class of unsaturated organic compounds containing one or more functional groups including carboxylic acid group (—COOH), anhydride group (—CO—O—CO—), hydroxyl group (—OH), ether group (—OR, R is a hydrocarbon radical), primary, secondary and tertiary amine groups and ester group. The term EPDM refers to elastomeric terpolymers comprising of 15% to 70% by weight, preferably between 20% and 45% by weight, of propylene, from 20% to 80% by weight of ethylene and from 2% to 15% by weight of a diene, for example, 1,4-hexadiene, norbornadiene, ethylidene-norbornene, dicyclopentadiene, butadiene and isoprene. The EPDM used here also includes functionally modified versions of terpolymers containing the functional groups herein mentioned above.

EPR and EPDM rubbers are readily commercially available as for example under the trade designation “Vistalon” from ExxonMobil Chemical Company, “RexFlex” from Huntsman Corporation, “AdFlex” from Basell Plastics, and “Kelton” from DSM Company, Inc. Functionally modified EPDM containing anhydride groups are sold under the trade name Exxelor by Exxon Chemical Company.

Among the useful elastomers are Fluoroelastomers. FKM is the designation for about 80% of fluoroelastomers as defined in ASTM D1418. Other fluorinated elastomers are perfluoro elastomers (FFKM) and tetrafluoro ethylene/propylene rubbers (FEPM). Originally developed by DuPont (Viton), FKMs are today also produced by Daikin Chemical (Dai-El), 3M's Dyneon (Dyneon Fluoroelastomers) and Solvay-Solexis (Tecnoflon). FKMs can be divided into different classes on the basis of either their chemical composition, their fluorine content or their crosslinking mechanism.

Types of FKM

On the basis of their chemical composition FKMs can be divided into the following types:

Type 1 FKMs are composed of vinylidene fluoride (VDF) and hexafluoropropylene (HFP). Copolymers are the standard type of FKMs showing a good overall performance. Their fluorine content typically ranges around 66 weight percent.

Type 2 FKMs are composed of VDF, HFP, and tetrafluoroethylene (TFE). Terpolymers have a higher fluorine content compared to copolymers (typically between 68 and 69 weight percent fluorine), which results in better chemical and heat resistance.

Type 3 FKMs are composed of VDF, HFP, TFE, perfluoromethylvinylether (PMVE). The addition of PMVE provides better low temperature flexibility compared to copolymers and terpolymers. Typically the fluorine content of type 3 FKMs ranges from 62 to 68 weight percent.

Type 4 FKMs are composed of propylene, TFE, and VDF. Base resistance is increased in type 4 FKMs. Typically they have a fluorine content of about 67 weight percent.

Type 5 FKMs are composed of VDF, HFP, TFE, PMVE, and Ethylene. Type 5 FKM is known for base resistance and high temperature hydrogen sulfide resistance.

Particular embodiments of fluoroelastomers include Dai-El™ form Daikin, Fluorel™ from 3M, Technoflon™ from Solvay and Viton® from DuPont. Particular embodiments of Perfluoroelastomers include Chemraz™, Kalrez® from DuPont, Perfluor™ from Kyoritsu, Simriz™ from Simrit and Zalak™ from DuPont.

Silicone Elastomers

Another useful elastomer is a silicone elastomer. Among useful silicone elastomers are crosslinked silicone polymers. The silicone polymer may, for example, include polyalkylsiloxanes, such as silicone polymers formed of a precursor, such as dimethylsiloxane, diethylsiloxane, dipropylsiloxane, methylethylsiloxane, methylpropylsiloxane, or combinations thereof. In a particular embodiment, the polyalkylsiloxane includes a polydialkylsiloxane, such as polydimethylsiloxane (PDMS). In a particular embodiment, the polyalkylsiloxane is a silicone hydride-containing polydimethylsiloxane. In a further embodiment, the polyalkylsiloxane is a vinyl-containing polydimethylsiloxane.

In yet another embodiment, the silicone polymer is a combination of a hydride-containing polydimethylsiloxane and a vinyl-containing polydimethylsiloxane. In an example, the silicone polymer is non-polar and is free of halide functional groups, such as chlorine and fluorine, and of phenyl functional groups. Alternatively, the silicone polymer may include halide functional groups or phenyl functional groups. For example, the silicone polymer may include fluorosilicone or phenylsilicone. Suitable silicone polymers as described in the art include MQ silicone polymers having only methyl groups on the polymer chain; VMQ silicone polymers having methyl and vinyl groups on the polymer chain; PMQ silicone polymers having methyl and phenyl groups on the polymer chain; PVMQ silicone polymers having methyl, phenyl and vinyl groups on the polymer chain; and FVMQ silicone polymers having methyl, vinyl and fluoro groups on the polymer chain. Particular embodiments of these elastomers include the Silastic® silicone elastomers from Dow Corning.

The silicone formulation may further include a catalyst and other optional additives. Exemplary additives may include, individually or in combination, fillers, inhibitors, colorants, and pigments. In an embodiment, the silicone formulation is a platinum catalyzed silicone formulation. Alternatively, the silicone formulation may be a peroxide catalyzed silicone formulation. In another example, the silicone formulation may be a combination of a platinum catalyzed and peroxide catalyzed silicone formulation. The silicone formulation may be a room temperature vulcanizable (RTV) formulation or a gel. In an example, the silicone formulation may be a liquid silicone rubber (LSR) or a high consistency gum rubber (HCR). In a particular embodiment, the silicone formulation is a platinum catalyzed LSR. In a further embodiment, the silicone formulation is an LSR formed from a two-part reactive system.

The silicone formulation may be a conventional, commercially prepared silicone polymer. The commercially prepared silicone polymer typically includes the non-polar silicone polymer, a catalyst, a filler, and optional additives. “Conventional” as used herein refers to a commercially prepared silicone polymer that is free of any self-bonding moiety or additive. Particular embodiments of conventional, commercially prepared LSR include Wacker Elastosil® LR 3003/50 by Wacker Silicone of Adrian, Mich. and Rhodia Silbione® LSR 4340 by Rhodia Silicones of Ventura, Calif. In another example, the silicone polymer is an HCR, such as Wacker Elastosil® R4000/50 available from Wacker Silicone. Or HS-50 High Strength HCR available from Dow Corning.

In an exemplary embodiment, a conventional, commercially prepared silicone polymer is available as a two-part reactive system. Part 1 typically includes a vinyl-containing polydialkylsiloxane, a filler, and catalyst. Part 2 typically includes a hydride-containing polydialkylsiloxane and optionally, a vinyl-containing polydialkylsiloxane and other additives. A reaction inhibitor may be included in Part 1 or Part 2. Mixing Part 1 and Part 2 by any suitable mixing method produces the silicone formulation. In an exemplary embodiment, the two-part system are mixed in a mixing device. In an example, the mixing device is a mixer in an injection molder. In another example, the mixing device is a mixer, such as a dough mixer, Ross mixer, two-roll mill, or Brabender mixer.

Any of the elastomeric polymer types described in the preceding paragraphs may be compounded with catalysts or curatives, fillers, pigments, processing aids, flame retardants and other additives. Typical catalysts or curatives for elastomeric compositions include organic peroxides, platinum, palladium, rhodium, ruthenium or organotin catalysts. Organic peroxides include di-tert-butyl peroxide, tert-butyl cumyl peroxide, dicumyl peroxide, tert-butyl peroxybenzoate, dibenzoyl peroxide, di-(4-methylbenzoyl)peroxide, and di-2,4-dichlorobenzoyl peroxide. Suitable organotin catalysts include, for example, dibutyl tin dilaurate, dibutyl tin diacetate, dioctyl tin maleate, organotitanates etc. Thermoplastic elastomers may alternatively be processed without catalysts.

General Description

In a typical process the elastomer may be compounded or mixed with curatives and other additives such as fillers, pigments and processing aids in a piece of equipment such as a rubber mill, an internal mixer or a high intensity mixer. Such equipment contains two or more rolls meeting at nip points for compressing and mixing the rubber composition. After the composition has been uniformly mixed with the appropriate components, it may be formed to a controlled thickness using another piece of equipment with rotating rolls spaced at a controlled gap. Such equipment is known as a calender. Calendering may be used to produce an unreinforced elastomeric membrane, or in some cases, the elastomer may be formed with a reinforcing fabric by feeding such as fabric at the same time through the calendar. The elastomeric membrane may then be formed to shape and cured by the application of heat and pressure in a mold.

In order to calender elastomers to uniform, controlled thickness, calenders must be engineered for precise control and deformation resistance. As a calender becomes wider, engineering requirements necessitate heavier, thicker, more robust construction and correspondingly increased cost. Using the mold processes disclosed herein allows for wide width membranes to be formed from strips produced by narrower calenders at lower cost, and in sizes heretofore not achievable by current calendering technology. In one aspect, the use of uncured materials in the process provides an advantage to form membranes of various sizes and without discontinuities associated with the formation of a seam.

While these are general steps common to elastomer membrane fabrication, they are meant to be illustrative of the process steps, but variants of these steps individually, or in together, will be known to those skilled in the art. For example, if a thermoplastic elastomer is used for this invention, then curatives may be optional.

When a reinforcing fabric is used such fabric reinforcement may include polyester, fiberglass, aramide, polyimide, carbon fiber, and other suitable woven or nonwoven fabric constructions. The reinforcement may also be included as chopped fiber.

In one embodiment the reinforcing fabric further comprises a milled elastomer composition adhered to one or both sides. This may be accomplished by passing the fabric and a quantity of milled, compounded elastomer through a calender, forming a controlled thickness and adhering it to the reinforcing fabric. A preferred method is to adhere this to one side of the fabric, with a small amount of elastomer bleeding through to the reverse side.

This reinforced calendered sheet may be cut to narrow strips of a suitable dimension to cover the edge zone of the laminator to be supplied. This would extend through the clamping and edge flexing region, and would typically be about 12 inches for a production PV module laminator, although the exact size may vary with total equipment size or design. The composition may remain uncured at this stage.

The reinforced sheet may be applied at the perimeter of the membrane body. It may be applied by a variety of manual or automated methods and may comprise one or multiple pieces arranged around the perimeter. In one embodiment, the reinforced sheet is thinner than the body membrane elastomer. While not limited by theory, we believe that the use of a thinner reinforcement strip below or just at the edge of the thicker unreinforced sheet allows a partial flow and leveling to occur in the edge zone, resulting in a substantially uniform thickness throughout the entire membrane In one embodiment, the body membrane thickness is about 0.075 to 0.200 inches or about 0.125 to 0.150 inches. In one embodiment, the thickness of the edge reinforcement sheet is between about 5 and 50% of the thickness of the body membrane sheet or between about 10 and 20% of the thickness of the body membrane sheet.

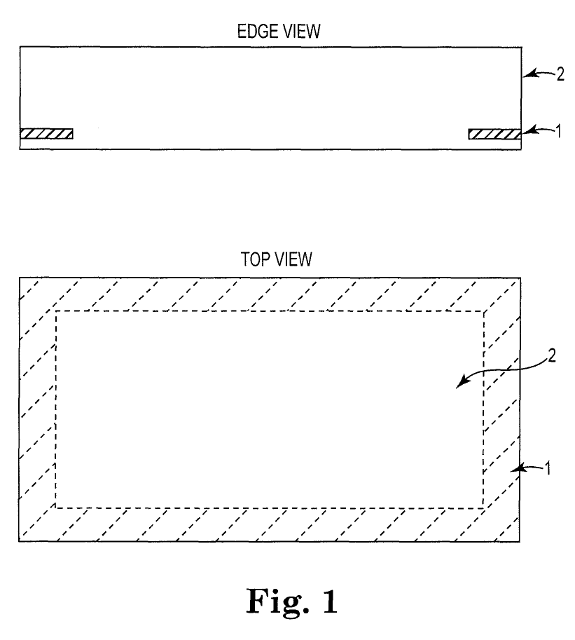

FIG. 1 provides one aspect of the invention. In FIG. 1, elastomer 2 is shown as a unitary membrane about the entire structure. Reinforcement layer 1 is located about the perimeter of the construct. In one aspect, a reinforcement material has been embedded with an elastomeric composition to form reinforcement layer 1. Reinforcement layer 1 is then applied to elastomer 2 of the unitary membrane. In another aspect, reinforcement material, such as a nonwoven, a mesh, or fibers, can be applied directly to elastomer 2 for forming the reinforced structure.

In an alternative embodiment, layer 1 can be located between two layers of elastomer 2 or embedded within a single layer of elastomer 2. Therefore, FIG. 1 should not be construed as limiting and is only one embodiment of the present invention. It should also be understood that reinforcement layer 1 can be located at the outermost edge of the construct or positioned near the edge, such that a portion of the edge of layer 1 is not reinforced. This can provide the ability to utilize the unreinforced edge layer for other purposes. In one aspect, the unreinforced edge layer can be “wrapped” about reinforcement layer 1 so that layer 1 is completely covered or partially covered by the excess portion of the edge layer.

To form the item of this invention the following process steps can be used:

1. A high consistency rubber with curatives is compounded using a two roll mill. Typical rubber materials that can be used include silicone elastomers, EPDM, fluorosilicones, FKM and the like, such as Dow Corning HS 50, HS 70 or HS30. Typical curatives include, but are not limited to, organic peroxides such as di-tert-butyl peroxide, tert-butyl cumyl peroxide, dicumyl peroxide, tert-butyl peroxybenzoate, dibenzoyl peroxide, di(4-methylbenzoyl)peroxide, di-2,4-dichlorobenzoyl peroxide. The elastomer, when exiting the mill, should not be cured.

2. A quantity of the compounded rubber from step 1 above is passed through a calendar to form a controlled thickness and adhere it to a reinforcing fabric. In one embodiment, the method is to adhere the milled elastomer to one side of the fabric, with a small amount of elastomer bleeding through to the reverse side. The invention can also be practiced by calendering rubber (elastomer) on to both sides of a reinforcing fabric. Fabric reinforcement can include glass fiber, nylon, polyester, aramid, steel mesh, polyimide, carbon and other suitable woven or nonwoven fabric constructions. Reinforcement can also include chopped fiber.

3. The reinforced calendered sheet from Step 2 above can then be cut to narrow strips of a suitable dimension to cover the edge zone of a laminator. This would extend through the clamping and edge flexing region, and would typically be about 12 inches for a production PV module laminator, although the exact size may vary with total equipment size or design. Total thickness for this structure could be about 0.042 inches, of which about 0.017 inches would comprise the reinforcing fabric. The composition has still not been cured at this step.

4. The remaining compounded rubber batch from step 1 is calendered to a controlled thickness. In one embodiment, the same composition for the reinforced strip and the body of the diaphragm is used although it is not required that the materials be the same composition, nor even the same elastomer type, as long as the edge strip and the central body compositions are capable of curing together during the subsequent molding composition. Again, the composition is not cured at this step. The thickness of this sheet should be about 0.075 to 0.200 inches, or about 0.125 to 0.150 inches.

5. A mold is preheated. The mold is sized for the particular laminator membrane to be produced.

6. The reinforced elastomer sheet is assembled with the unreinforced elastomer sheet outside the mold on a work table or similar. Preferably, the thin strips of reinforced elastomer are cut to appropriate length and placed along the edges of the unreinforced elastomer sheet. Typically, the natural tackiness of the uncured formulations will serve to hold them in contact during assembly. This assembly can then be transferred to hot mold. Alternatively it is possible to assemble the unreinforced and reinforced elastomer sheets directly in the mold.

7. The mold is closed and the membrane is cured with heat and pressure. Typical conditions are from about 260° F. to about 330° F. and from about 10 minutes to about 40 minutes.

8. The fabricated diaphragm is then removed from the mold. Depending on the formulation, the diaphragm may be post cured in an oven, for example, for up to about 12 hours at 480° F.

As calendaring technology develops, larger sheets of membrane can be formed. For example sheets approximately 4 meters wide could be used to fabricate the membranes, the various components of the reinforced pliable membrane and perimeter reinforced pliable membranes described above. For example, a continuous substrate can be passed through a calendaring process with a supporting substrate layer pre-applied to the east and west edges (left and right edges) As the membrane and supporting substrate are calendared, the supporting substrate is embedded into the membrane. Alternatively, or in addition to simply calendaring, an adhesive can also be applied. Additionally, prior to the substrate entering the calendar, a reinforcement layer can be positioned at appropriate intervals to construct the North-South portions of the final perimeter reinforcement. Again, alternatively, the support substrate can be applied with an adhesive.

In an alternative embodiment, a two ply membrane can be prepared as described above, wherein the support substrate is sandwiched between two or more sheets of membrane with or without adhesive applied between the membrane and support.

The following paragraphs enumerated consecutively from one (1) through 51 provide for various aspects of the present invention. In one embodiment, in a first paragraph (1), the present invention provides a perimeter reinforced pliable membrane comprising a pliable membrane comprising a perimeter and an interior portion, wherein the perimeter of the pliable membrane is reinforced with a supporting substrate and the interior portion does not comprise the supporting substrate.

2. The perimeter reinforced pliable membrane of paragraph 1, wherein the pliable membrane is seamless.

3. The perimeter reinforced pliable membrane of paragraph 1, wherein the pliable membrane and reinforced perimeter of the membrane are both seamless.

4. The perimeter reinforced pliable membrane of any of paragraphs 1 through 3, wherein the perimeter reinforced pliable membrane dimensions are at least about 1 meters by 1 meters.

5. The perimeter reinforced pliable membrane of any of paragraphs 1 through 3, wherein the perimeter reinforced pliable membrane dimensions are at least about 2 meters by 3 meters.

6. The perimeter reinforced pliable membrane of any of paragraphs 1 through 3, wherein the perimeter reinforced pliable membrane dimensions are at least about 3 meters by 5 meters.

7. The perimeter reinforced pliable membrane of any of paragraphs 1 through 6, wherein the pliable membrane comprises an elastomer.

8. The perimeter reinforced pliable membrane of paragraph 7, wherein the elastomer is an ethylene propylene diene M-class rubber, a silicone elastomer, a fluorosilicone, an FKM, EPDM, IIR, or butyl rubber.

9. The perimeter reinforced pliable membrane of any of paragraphs 1 through 8 wherein the supporting substrate is a fabric, chopped fibers, or nonwoven.

10. The perimeter reinforced pliable membrane of paragraph 9, wherein the fabric or nonwoven is selected from glass fibers, nylons, polyesters, aramids, steel meshes, polyimides, carbon fiber or mixtures thereof.

11. The perimeter reinforced pliable membrane of any of paragraphs 7 through 10, wherein the elastomer further comprises a curing agent.

12. The perimeter reinforced pliable membrane of paragraph 11, wherein the curing agent is an organic peroxide, a platinum, palladium, ruthenium or organotin catalyst.

13. The perimeter reinforced pliable membrane of paragraph 12, wherein the organic peroxide is di-tert-butyl peroxide, tert-butyl cumyl peroxide, dicumyl peroxide, tert-butyl peroxybenzoate, dibenzoyl peroxide, di(4-methylbenzoyl)peroxide, di-2,4-dichlorobenzoyl peroxide or mixtures thereof.

14. A molded perimeter reinforced pliable membrane comprising a pliable membrane comprising a perimeter and an interior portions, wherein the perimeter of the pliable membrane is reinforced with a supporting substrate and the interior portion does not comprise the supporting substrate.

15. The molded perimeter reinforced pliable membrane of paragraph 14, wherein the pliable membrane is seamless.

16. The molded perimeter reinforced pliable membrane of paragraph 15, wherein the pliable membrane and reinforced perimeter of the membrane are both seamless.

17. The molded perimeter reinforced pliable membrane of any of paragraphs 14 through 16, wherein the perimeter reinforced pliable membrane dimensions are at least about 1 meters by 1 meters.

18. The molded perimeter reinforced pliable membrane of any of paragraphs 14 through 16, wherein the perimeter reinforced pliable membrane dimensions are at least about 2 meters by 3 meters.

19. The molded perimeter reinforced pliable membrane of any of paragraphs 14 through 16, wherein the perimeter reinforced pliable membrane dimensions are at least about 3 meters by 5 meters.

20. The molded perimeter reinforced pliable membrane of any of paragraphs 14 through 19, wherein the pliable membrane comprises an elastomer.

21. The molded perimeter reinforced pliable membrane of paragraph 20, wherein the elastomer is an ethylene propylene diene M-class rubber, a silicone elastomer, a fluorosilicone, an FKM, EPDM, IIR, or butyl rubber.

22. The molded perimeter reinforced pliable membrane of any of paragraphs 14 through 21 wherein the supporting substrate is a fabric, chopped fibers or nonwoven.

23. The molded perimeter reinforced pliable membrane of paragraph 22, wherein the fabric or nonwoven is selected from glass fibers, nylons, polyesters, aramids, steel meshes, polyimides, carbon fiber or mixtures thereof.

24. The molded perimeter reinforced pliable membrane of any of paragraphs 20 through 23, wherein the elastomer further comprises a curing agent.

25. The molded perimeter reinforced pliable membrane of paragraph 24, wherein the curing agent is an organic peroxide, a platinum, palladium, ruthenium or organotin catalyst.

26. The molded perimeter reinforced pliable membrane of paragraph 21, wherein the organic peroxide is di-tert-butyl peroxide, tert-butyl cumyl peroxide, dicumyl peroxide, tert-butyl peroxybenzoate, dibenzoyl peroxide, di(4-methylbenzoyl)peroxide, di-2,4-dichlorobenzoyl peroxide or mixtures thereof.

27. A process to provide a perimeter reinforced pliable membrane comprising the steps:

a) processing an elastomer, optionally with an additive to form a first mixture;

b) contacting the first mixture with a fiber supporting substrate to form a supported sheet wherein a portion of the mixture is integrally enjoined within or about individual fibers of the supporting substrate to provide a reinforced material;

c) sizing the reinforced material to a dimension suitable to cover an edge zone of a laminator or other pressure membrane device;

d) processing an elastomer, optionally with an additive to form a second mixture;

e) processing the second mixture into a sheet;

f) layering of the reinforced material about the perimeter of the sheet to provide an uncured perimeter reinforced pliable membrane; and

g) mold processing the uncured perimeter reinforced pliable membrane to form a perimeter reinforced pliable membrane.

28. The method of paragraph 27, wherein the first and second mixture are the same.

29. The method of paragraph 27, wherein step c) provides pieces of reinforced material are sized at angles such that the edges of the angles fit together.

30. The molded perimeter reinforced pliable membrane of either of paragraphs 7 or 8 wherein the elastomer further comprises a thermoplastic elastomer.

31. The molded perimeter reinforced pliable membrane of any of paragraphs 20 or 21 wherein the elastomer further comprises a thermoplastic elastomer.

32. A molded pliable membrane comprising a pliable membrane comprising a perimeter and an interior portion, wherein the pliable membrane is a size of at least about 2 meters by 3 meters.

33. The molded pliable membrane of paragraph 32, wherein the pliable membrane is seamless.

34. The molded pliable membrane of any of either paragraphs 32 or 33, wherein the pliable membrane dimensions are at least about 3 meters by 5 meters.

35. The molded pliable membrane of any of paragraphs 32 through 34, wherein the pliable membrane comprises an elastomer.

36. The molded pliable membrane of paragraph 35, wherein the elastomer is an ethylene propylene diene M-class rubber, a silicone elastomer, a fluorosilicone, an FKM, EPDM, IIR, or butyl rubber.

37. The molded pliable membrane of either of paragraphs 35 or 36, wherein the elastomer further comprises a curing agent.

38. The molded pliable membrane of paragraph 37, wherein the curing agent is an organic peroxide, a platinum, palladium, ruthenium or organotin catalyst.

39. The molded pliable membrane of paragraph 38, wherein the organic peroxide is di-tert-butyl peroxide, tert-butyl cumyl peroxide, dicumyl peroxide, tert-butyl peroxybenzoate, dibenzoyl peroxide, di(4-methylbenzoyl)peroxide, di-2,4-dichlorobenzoyl peroxide or mixtures thereof.

40. A molded seamless pliable membrane comprising a pliable membrane comprising a perimeter and an interior portions, wherein the molded seamless pliable membrane is constructed of at least two sheets of uncured membrane material, that when cured to each other, form the molded seamless pliable membrane of a size of at least about 2 meters by 3 meters.

41. The molded seamless pliable membrane of paragraph 40, wherein the molded seamless pliable membrane dimensions are at least about 3 meters by 5 meters.

42. The molded seamless pliable membrane of either paragraphs 40 or 41, wherein the pliable membrane comprises an elastomer.

43. The molded seamless pliable membrane of paragraph 42, wherein the elastomer is an ethylene propylene diene M-class rubber, a silicone elastomer, a fluorosilicone, an FKM, EPDM, IIR, or butyl rubber.

44. The molded seamless pliable membrane of either of paragraphs 42 or 43, wherein the elastomer further comprises a curing agent.

45. The molded seamless pliable membrane of paragraph 44, wherein the curing agent is an organic peroxide, a platinum, palladium, ruthenium or organotin catalyst.

46. The molded seamless pliable membrane of paragraph 45, wherein the organic peroxide is di-tert-butyl peroxide, tert-butyl cumyl peroxide, dicumyl peroxide, tert-butyl peroxybenzoate, dibenzoyl peroxide, di(4-methylbenzoyl)peroxide, di-2,4-dichlorobenzoyl peroxide or mixtures thereof.

47. A process to provide a seamless pliable membrane comprising the steps:

a) processing an elastomer, optionally with an additive to form a first mixture;

b) processing the first mixture into an uncured sheet;

c) processing an elastomer, optionally with an additive to form a second mixture;

e) processing the second mixture into an uncured sheet; and

f) mold processing and curing the first and second uncured sheets to each other to form a seamless pliable membrane.

48. The method of paragraph 47, wherein the first and second mixture are the same.

49. A process to provide a perimeter reinforced seamless pliable membrane comprising the steps:

a) processing an elastomer, optionally with an additive to form a first mixture;

b) processing the first mixture into a first uncured sheet;

c) processing an elastomer, optionally with an additive to form a second mixture;

e) processing the second mixture into a second uncured sheet;

f) placing an edge of the first and second uncured sheets in contact with each other to form an intermediate uncured sheet;

g) placing a reinforcement material about the perimeter of the intermediate uncured sheet; and

h) mold processing and curing the first and second uncured sheets of the intermediate uncured sheet to each other to form a seamless pliable membrane.

50. The method of paragraph 49, wherein the first and second mixture are the same.

51. The pliable membrane or process of any of paragraphs 1 through 50, wherein the pliable membrane is used within a photovoltaic module laminator.

The invention will be further described with reference to the following non-limiting Examples. It will be apparent to those skilled in the art that many changes can be made in the embodiments described without departing from the scope of the present invention. Thus the scope of the present invention should not be limited to the embodiments described in this application, but only by embodiments described by the language of the claims and the equivalents of those embodiments. Unless otherwise indicated, all percentages are by weight.

### EXAMPLES

### Exemplary Elastomeric Composition (all % Expressed as % by Weight)

| | |
|---|---|
| Dow Corning HS-50 (High Strength HCR rubber) | 94% |
| Black Pigment | 1.8% |
| Dow Corning J GR-90 STI (Grey Pigment Masterbatch) | 1.8% |
| Varox DBPH-50 Peroxide | 1% |
| Dow Corning HT-1 (High Temperature additive) | 1% |
| Dow Corning HA-2 (Softener-Processing aid) | 0.4% |

### Example 1

### Preparation of a 3 Meter by 5 Meter Molded, Edge Reinforced Elastomeric Membrane Having a Thickness 3 Mm

1. The elastomeric composition to be molded would be mixed in a two-roll rubber mill. The composition would be allowed to rest undisturbed for a relaxation period of about eight hours. After this period the elastomer mix would be calendered on a three-roll rubber calender to a thickness of about 3.1 mm and disposed on a carrier, such as polyethylene liner, Teflon coated fiberglass, silicone release sheets, or other suitable carrier. The calendered sheet would be formed to a width of approx. 41 inches and cut to a length of approximately 5.1 meters. The thickness of this sheet should be about 0.075 to 0.200 inches, or about 0.125 to 0.150 inches.

2. In a machine assisted process, three rolls of the formed sheet would be loaded onto a carrier in a common loading sled. This loading sled would be fixed above the loading/un-loading table of a press.

3. The loading sled would be then positioned to lay down the three sheets of pre-form within the mold so that the edges slightly overlapped each other. A one inch overlap would be used. The carrier would be removed as each of the preforms are laid down onto the mold

4. An edge reinforcement material would be positioned in the appropriate edge location on top of the pre-form. The edge reinforcement would be formed by passing a suitable reinforcing fabric and a quantity of milled, compounded elastomer through a calender, which would provide a controlled thickness and would be adhered to the reinforcing fabric. One method would be to adhere this to one side of the fabric, with a small amount of elastomer bleeding through to the reverse side. The elastomer of the reinforcing strip would be the same or different from the elastomer used in the body of the membrane. Total thickness for this structure would be about 0.042 inches, of which about 0.017 inches comprised the reinforcing fabric.

5. The mold cavity would be carried back into the press and the cure cycle would be initiated. A cure time of 20 minutes at a temperature of 310° F. would be used.

6. Once the cure was complete, the mold would be opened and the membrane would be conveyed onto a post-cure festoon rack. At this point, it may be removed from the area for post cure in another location, if desired.

7. A post cure within an oven could be used, with a cycle comprising 4 hours ramping to a temperature of 480° F., followed by holding at 480° F. for 4 hours, followed by cool down and removal from the oven.

8. Following post-cure, membranes could be trimmed, inspected, cut (if required) to a smaller size, and packaged.

While this process example is described as a single membrane cycle, the process may be automated such that as a cured membrane emerges from the press, a loaded sled is available to load the next set of elastomer pieces to be cured. While the second membrane is being cured, the first may be transported to the post cure location.

The above process can be adjusted for time and temperature depending on the elastomeric composition and the sizes may be adjusted depending on the dimensions of the mold, and the desired size of the finished membrane. While the process has been described with a reinforced edge, a large membrane of unreinforced construction may also be prepared by this sequence of stacking overlapped pieces and curing.

### Example 2

### Preparation of a 36 Inch by 36 Inch Molded Elastomeric Membrane Having a Thickness of Between 4 and 5 Mm

1. The elastomeric composition given above for example 1 was mixed on a two-roll rubber mill. The composition was allowed to rest undisturbed for a relaxation period of about eight hours. After this period the elastomer mix was calendered on a three-roll rubber calender to a thickness of about 3-5 mm and disposed on a carrier, such as polyethylene liner, Teflon coated fiberglass, silicone release sheets, or other suitable carrier. The calendered sheet was taken up in roll form by placing a second release sheet on the top surface. The calendered sheet was formed to a width of approximately 36 inches.

2. An approximately 36 inch long sheet of pre-form was cut from this calendered roll, removed from between the carriers and laid within the mold cavity.

3. The mold was placed into a press and the cure cycle was initiated. A cure time of 20 minutes at a temperature of 310° F. was used.

4. Once the cure was complete, the mold was opened and the membrane moved to a post cure oven.

5 The membrane was post cured within the oven, using a cycle comprising 4 hours ramping to a temperature of 480° F., followed by holding at 480° F. for 4 hours, followed by cool down and removal from the oven.

6. Following post-cure, the membrane was trimmed, and inspected.

Although the present invention has been described with reference to preferred embodiments, persons skilled in the art will recognize that changes may be made in form and detail without departing from the spirit and scope of the invention. All references cited throughout the specification, including those in the background, are incorporated herein in their entirety. Those skilled in the art will recognize, or be able to ascertain, using no more than routine experimentation, many equivalents to specific embodiments of the invention described specifically herein. Such equivalents are intended to be encompassed in the scope of the following claims.

What is claimed is:

1. A perimeter reinforced pliable membrane comprising:
a pliable membrane comprising a perimeter and an interior portion, wherein the perimeter of the pliable membrane is reinforced with a supporting substrate and the interior portion does not comprise the supporting substrate.

2. The perimeter reinforced pliable membrane of claim 1, wherein the pliable membrane is seamless.

3. The perimeter reinforced pliable membrane of claim 1, wherein the perimeter reinforced pliable membrane dimensions are at least about 1 meters by 1 meters.

4. The perimeter reinforced pliable membrane of claim 1, wherein the pliable membrane comprises an elastomer.

5. The perimeter reinforced pliable membrane of claim 4, wherein the elastomer is an ethylene propylene diene M-class rubber, a silicone elastomer, a fluorosilicone, an FKM, EPDM, IIR, or butyl rubber.

6. The perimeter reinforced pliable membrane of claim 1, wherein the supporting substrate is a fabric, chopped fibers, or nonwoven.

7. The perimeter reinforced pliable membrane of claim 6, wherein the fabric or nonwoven is selected from glass fibers, nylons, polyesters, aramids, steel meshes, polyimides, carbon fiber or mixtures thereof.

8. The perimeter reinforced pliable membrane of claim 4, wherein the elastomer further comprises a curing agent.

9. A molded perimeter reinforced pliable membrane comprising:
a pliable membrane comprising a perimeter and an interior portions, wherein the perimeter of the pliable membrane is reinforced with a supporting substrate and the interior portion does not comprise the supporting substrate.

10. The molded perimeter reinforced pliable membrane of claim 9, wherein the pliable membrane is seamless.

11. The molded perimeter reinforced pliable membrane of claim 9, wherein the perimeter reinforced pliable membrane dimensions are at least about 1 meters by 1 meters.

12. The molded perimeter reinforced pliable membrane of claim 9, wherein the pliable membrane comprises an elastomer.

13. The molded perimeter reinforced pliable membrane of claim 12, wherein the elastomer is an ethylene propylene diene M-class rubber, a silicone elastomer, a fluorosilicone, an FKM, EPDM, IIR, or butyl rubber.

14. The molded perimeter reinforced pliable membrane of claim 9, wherein the supporting substrate is a fabric, chopped fibers or nonwoven.

15. The molded perimeter reinforced pliable membrane of claim 15, wherein the fabric or nonwoven is selected from glass fibers, nylons, polyesters, aramids, steel meshes, polyimides, carbon fiber or mixtures thereof.

16. The molded perimeter reinforced pliable membrane of claim 12, wherein the elastomer further comprises a curing agent.

17. A process to provide a perimeter reinforced pliable membrane comprising the steps:
a) processing an elastomer, optionally with an additive to form a first mixture;
b) contacting the first mixture with a fiber supporting substrate to form a supported sheet wherein a portion of the mixture is integrally enjoined within or about individual fibers of the supporting substrate to provide a reinforced material;
c) sizing the reinforced material to a dimension suitable to cover an edge zone of a laminator or other pressure membrane device;
d) processing an elastomer, optionally with an additive to form a second mixture;
e) processing the second mixture into a sheet;
f) layering of the reinforced material about the perimeter of the sheet to provide an uncured perimeter reinforced pliable membrane; and
g) mold processing the uncured perimeter reinforced pliable membrane to form a perimeter reinforced pliable membrane.

18. The method of claim 17, wherein the first and second mixture are the same.

19. The method of claim 17, wherein step c) provides pieces of reinforced material are sized at angles such that the edges of the angles fit together.
